(19) United States
(12) Patent Application Publication
(10) Pub. No.: US 2013/0213944 A1
(43) Pub. Date: Aug. 22, 2013

(54) System for Laser Direct Writing of MESA Structures Having Negatively Sloped Sidewalls

(71) Applicants: Olivier Dellea, La Talaudiere (FR); Pascal Fugier, Bernin (FR); Zoé Tebby, Le Grand Pressigny (FR)

(72) Inventors: Olivier Dellea, La Talaudiere (FR); Pascal Fugier, Bernin (FR); Zoé Tebby, Le Grand Pressigny (FR)

(73) Assignee: COMMISSARIAT A L'ENERGIE ATOMIQUE ET AUX ENERGIES ALTERNATIVES, Paris (FR)

(21) Appl. No.: 13/882,194

(22) PCT Filed: Oct. 18, 2011
(86) PCT No.: PCT/EP2011/068168

§ 371 Date: Apr. 28, 2013

(30) Foreign Application Priority Data
Oct. 27, 2010 (FR) 1058832

(51) Int. Cl. B23K 26/02

(52) U.S. Cl. CPC B23K 26/02
USPC 219/121.69; 219/121.68

(57) ABSTRACT

In the field of photolithography systems designed to produce electronic components using the technique known as “lift-off” on a plane substrate comprising one or more plane photosensitive layers, a system uses a laser direct-write technique. It comprises optical or mechanical means configured such that the useful part of the optical beam is inclined on the plane of the photosensitive layers in order to create profiles with an inverted slope within said layers, the useful part of the optical beam being the part of the optical beam which effectively contributes to creating said profiles. In one preferred embodiment, the system comprises means for partial shuttering of the optical beam situated in the neighborhood of the focusing optics.

The field of the invention is that of maskless photolithography more precisely implementing the structuring by laser direct writing of photosensitive materials.

Indeed, the device and the method according to the invention can, for example, be used for the fabrication of electronic or optoelectronic components.

The device and the method according to the invention is directly applicable in the field of the microelectronics in order to notably implement a method known by the term “lift-off”.

This technique is a method that is well known in the field of microelectronics. It allows a thin film deposited onto a substrate to be structured without having to etch the materials forming the film. This technique is referred to as “additive”, as opposed to “subtractive”, because it does not comprise a step for direct etching of the materials forming the film. This technique is especially useful for the structuring of the metal layers whose etching solutions are sometimes complex and/or incompatible with the materials that are present.

“Lift-off” consists in forming the inverse image of the pattern to be formed on a substrate by means of a “stencil” layer. This stencil layer covers certain regions of the substrate and leaves other ones exposed. The film to be structured is subsequently deposited on top of the “stencil” layer. Then, the stencil layer is dissolved in a liquid. The dissolution of the stencil layer leads to the lifting off of the film deposited on its surface. The key point of the lift-off resides in the profile of the edges of the stencil layer. These edges must imperatively be inclined so as to create a rupture in the deposited film in order to allow the dissolution of the stencil layer.

The advantages of this “lift off” technique are:
Structuring the deposited film in a single step, without using a specific etching solution associated with the film generally composed of different materials;
Minimizing the risks of polluting the substrate because only one structuring step is applied;
Obtaining sloping pattern edges.
   The main drawback is the difficulty in creating the appropriate stencil.

In the field of lithography by masking, the stencil layer may be composed of:
A layer of photosensitive resist
Two layers which may be the following associations:
   photosensitive resist/photosensitive resist
   polyamide/molybdenum
   inorganic dielectric layer/photosensitive resist;
Three layers which may be the following associations:
   photosensitive resist/aluminum/photosensitive resist;
   polyamide/polysulfone/SiO

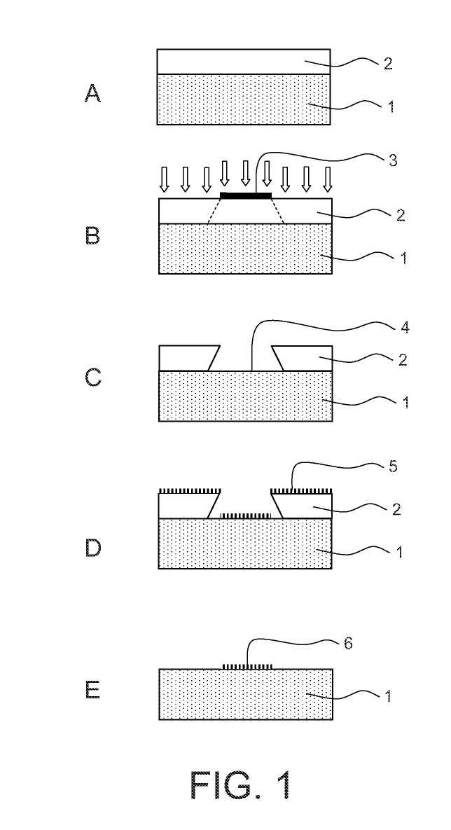

FIG. 1 illustrates the technique of “lift-off” implemented with a negative photosensitive resist, in other words the exposed part is dissolved during the development and during exposure under a mask. This technique comprises five main steps denoted A, B, C, D and E in FIG. 1. The step A consists in depositing a layer of resist 2 onto a substrate 1. The step B consists in depositing a mask 3 and exposing the resist 2, the masked parts not being exposed. The step C consists in dissolving or in developing the masked parts 4. The step D consists in uniformly depositing the film 5 to be structured. In the step E, the resist 2 is dissolved. The film 6 remains at the locations of the mask.

One of the conditions for the “lift-off” to work well is the provision of a clean break between the layer of material 5 deposited on the surface of the stencil and the layer of material 2 deposited on the substrate 1. This separation allows the solvent to come into contact with the stencil layer and to completely dissolve it. In order to provide this break, the edge of the resist opened at the step C must exhibit a profile in the shape of a “visor” guaranteeing the success of the “lift-off”. This is understood to mean an inclined profile with an inverted slope. The inverted slope does not allow the adhesion of the layer 5 on its sides. In the field of photolithography by masking, this technique is fully controlled.

However, there exist other photolithographic techniques such as laser direct-write photolithography. This laser direct-write technology allows, amongst other things, fast prototyping and customized components to be fabricated in small and medium volumes.

This technology relates to many technical sectors such as surface microstructuring, microfluidics, microelectronics, sensors, etc. Several companies have developed the method of laser direct writing with different technical approaches. The key technical points that differentiate these companies relate in particular to the conditioning of the laser beam and the management of the writing which may be obtained either by displacement of the laser beam, or by displacement of the substrate.

Thus, the company Heidelberg has developed a laser direct-write unit which comprises a system for deflection of the laser beam associated with a device displacing the substrate under the beam. The writing method developed by Heidelberg is referred to as a “scanning system” and consists in covering the whole surface of the substrate with the beam irrespective of the structuring to be carried out. The depth of field of the system developed by Heidelberg is limited by the deflection system.

The French company KLOE has developed a laser writing system which differs from that of the company Heidelberg in the following two points:
The beam is fixed; it is conditioned so as to have a large depth of field;
the writing method is referred to as a vector system, in other words the laser beam is only moved to the locations to be structured.

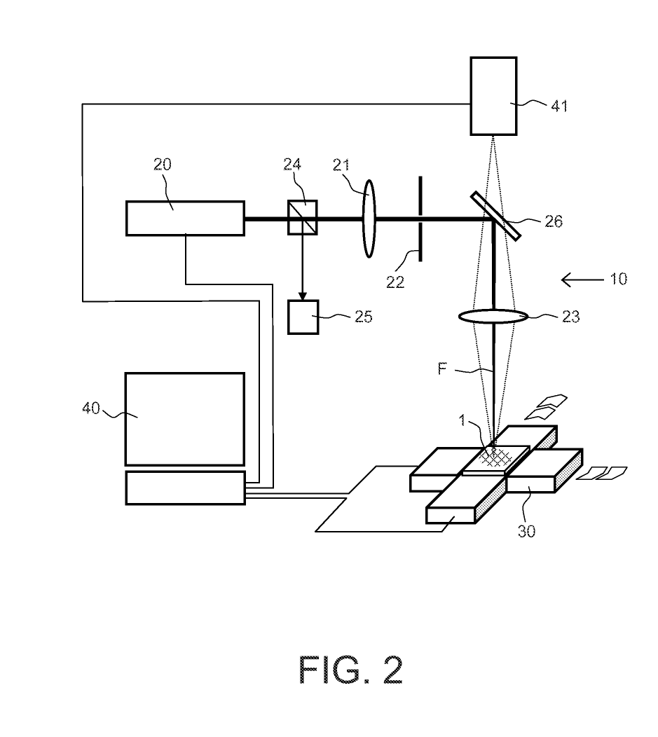

FIG. 2 shows a general view of a photolithography system using laser direct writing, similar to those developed by the company KLOE. The method of photolithography by laser direct writing consists in structuring a photosensitive thin layer by means of a focused laser beam being moved over the layer. In this approach, only the regions to be written are traversed by the laser beam, and this mode of writing is referred to as “vector writing”. In this type of equipment, in order to carry out high-resolution etches, it is important that the writing laser beam is focused on the photosensitive layers with a very small spot size, of the order of a micron, and that this beam has a large depth of field, in other words having a low divergence around the waist region of the laser beam.

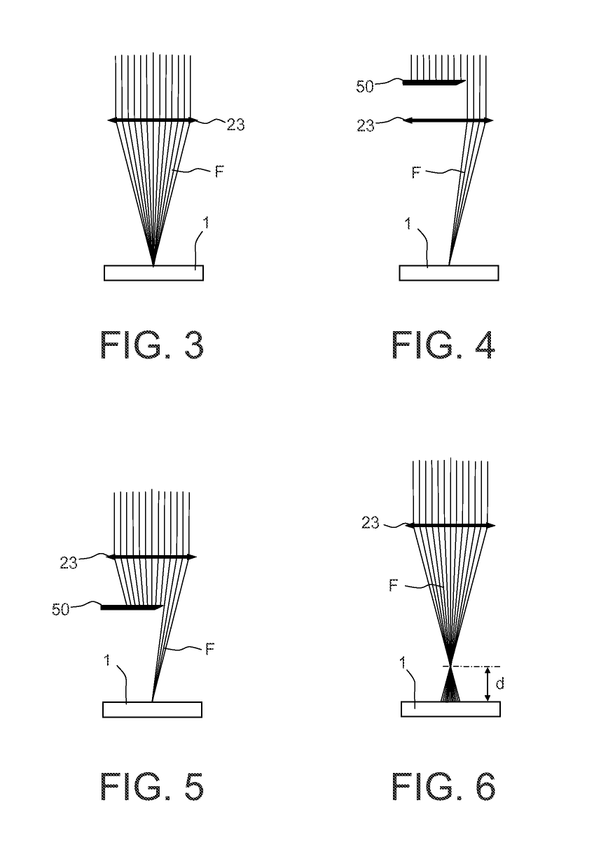

The writing system 10 essentially comprises two main parts:
An optical part: This optical part is composed of a UV laser source 20 emitting a beam F in the ultraviolet, of a device for conditioning the beam 21 and 22 and of a device 23 for focusing the beam F. This optical chain is fixed and allows a laser spot to be finally obtained whose size has dimensions close to that of the microstructures to be formed. FIG. 3 shows schematically the focusing of the beam F by the focusing device 23 on the substrate 1, via a single lens;
A mechanical part: This mechanical part is composed of translation tables 30 which allow the sample or the substrate 1 to be moved under the laser beam in the two directions of a plane substantially perpendicular to the laser beam.

The writing system also comprises control means which are:
means for managing the power of the UV laser source; these means are composed of a separator cube 24 and of a photodetector 25;
a control camera 41 which allows an image of the substrate to be formed in the visible range during the writing through the dichroic plate 26.

The whole system is controlled by a computer 40 which manages the UV source, the ignition and the extinction of the writing beam and coordinates the displacement of the translation tables.

The aim of the optical part is to supply a focused laser beam having an intensity profile that is as flat as possible in order to generate a uniform illumination associated with a large depth of field.

The laser source 20 is the optical element the furthest upstream in the assembly; its characteristics determine the quality of writing and influence the optical processing chain required. This source must notably have the following characteristics:
A long coherence length;
A narrow linewidth;
A low divergence;
A short wavelength so that the diffraction patterns are as small as possible on the substrate.

The device for conditioning the beam is needed to obtain a small circular spot at the focal point of the focusing lens 23. One possible arrangement consists in performing a spatial filtering by means of a circular aperture 22 diffracting the light. This circular aperture carries out the truncation of the incident beam and allows a constant intensity profile to be obtained at the focal point. Thus, light beams are obtained whose energy distribution is substantially constant. In addition, the size of the light spot at the focal point can be modified by simply changing the dimension of the calibrated aperture 22 without changing the focusing lens. However, the loss of light intensity in passing through the diffraction hole is considerable, the hole only allowing one percent of the incident energy to pass. In order to minimize these losses, a pre-focusing lens 21 can be positioned so as to concentrate the beam in passing through the diffraction hole 22.

One of the drawbacks of photolithography by laser direct writing is that it is difficult to obtain and to dynamically control the desired profiles in the shape of a “visor” guaranteeing the success of the “lift-off” process. The device according to the invention allows profiles of layers in the shape of a “visor” to be simply obtained without fundamentally modifying the existing systems.

More precisely, one subject of the invention is a laser direct-write system designed to form structures of the mesa type with an inverted slope on a substrate. The invention also relates to the use of such a system for the fabrication of electronic components by the technique known by the term “lift-off” on a plane substrate comprising one or more plane photosensitive layers.

Thus, one subject of the invention is a laser direct-write system designed to form structures of the mesa type, said system comprising at least:
a writing laser, the optical beam coming from the writing laser having radial symmetry;
a set of optics for focusing the optical beam onto the plane of the plane photosensitive layers;
means for displacement in translation of the plane substrate,
characterized in that the system comprises optical or mechanical means configured such that the useful part of the optical beam is inclined on the plane of the photosensitive layers in order to create profiles with an inverted slope within said layers, the useful part of the optical beam being the part of the optical beam which contributes effectively to creating said profiles.

Preferably, the writing laser beam originates from a laser source with a short wavelength emitting in the UV, in order to obtain a focused beam allowing the formation of patterns with micrometric dimensions. Amongst the lasers envisioned are notably laser diodes, gas lasers and solid lasers.

The choice of the focusing optics is not limiting. It may, for example, be a set of microscope focusing optics. It may have a variable focal length. The inclination of the sidewalls formed in the resist can thus be adjusted.

The optical or mechanical shuttering means may be chosen from amongst an opaque thin plane blade with a straight edge or an apodization blade, absorption filters, reflection filters, interference filters, neutral-density filters and polarizing filters.

The invention also relates to the use of a system such as defined hereinabove for the formation of inclined slopes in a resist.

In particular, the invention relates to the use of a system such as defined hereinabove for the performance of a step of a photolithographic method, notably a “lift-off” step.

The invention then consists in a method for laser direct writing on a substrate covered by a resist consisting in:
the provision of a laser writing system such as defined hereinabove,
the processing of said resist by the laser beam coming from the system.

Several embodiments are possible. In a first variant, the optical axis of the focusing optics is perpendicular to the plane of the photosensitive layers and the system comprises means for partial shuttering of the optical beam situated in the neighborhood of the focusing optics. The shuttering means are either an opaque thin plane blade with a straight edge or an apodization blade allowing an optical beam to be generated on the plane of the plane photosensitive layers such that the useful part of the optical beam is inclined on the plane of the photosensitive layers without diffraction fringes. Advantageously, the shuttering means are mounted onto at least one table being adjustable in translation and/or in rotation.

In a second variant, the optical beam has radial symmetry down to the level of the plane of the plane photosensitive layers, the optical axis of the focusing optics being perpendicular to the plane of the photosensitive layers, the optical beam being out of focus on the plane of the plane photosensitive layers.

Advantageously, the focusing optics introduces spherical aberration into the optical beam in such a manner that the caustic of spherical aberration on the plane of the plane photosensitive layers comprises more energy at the periphery than at its center.

The invention also relates to the use of a laser direct-write system as previously described for the performance of a step of a photolithographic method.

Lastly, it relates to a method of laser direct writing on a substrate covered by a resist consisting in:
the supply of a laser direct-write system as previously described;
the processing of said resist by the laser beam coming from this laser writing system.

The invention will be better understood and other advantages will become apparent upon reading the description that follows presented by way of non-limiting example and thanks to the appended figures amongst which:

FIG. 1, already commented, shows the main steps of the method known as “lift-off”;

FIG. 2 shows a general view of a laser writing system according to the prior art;

FIG. 3 shows the focusing of the writing beam onto the substrate according to the prior art;

FIGS. 4, 5 and 6 show schematically several variant embodiments according to the invention of the focusing of the writing beam on the substrate.

The general principle of the device according to the invention is to introduce into the writing system optical or mechanical means configured such that the useful part of the optical beam is inclined on the plane of the photosensitive layers in order to create profiles with an inverted slope within said layers, the useful part of the optical beam being the part of the optical beam which effectively contributes to creating said profiles.

Several embodiments are possible. They are shown in FIGS. 4 to 6. Each figure shows the beam F coming from the source 20 by a series of light rays, the focusing optics 23 and the substrate 1.

In a first variant illustrated in FIGS. 4 and 5, the optical axis of the focusing optics is perpendicular to the plane of the photosensitive layers and the system comprises means for partial shuttering 50 of the optical beam situated in the neighborhood of the focusing optics. In FIG. 4, the shuttering means are situated before the focusing optics and, in FIG. 5, the shuttering means are situated after the focusing optics. The shuttering means are either an opaque thin plane blade with a straight edge as illustrated in FIGS. 4 and 5, or an apodization blade, allowing an optical beam to be generated at the plane of the plane photosensitive layers such that the useful part of the optical beam is inclined on the plane of the photosensitive layers without diffraction fringes. Thus, the light rays reach the substrate at an angle with respect to the normal to the plane on which the substrate is resting. The shuttering means may be mounted on at least one table being adjustable in translation and/or in rotation so as to adjust the angle of incidence of the focusing beam. The major advantages of this technique are its simplicity of implementation, which require very few adaptations of the system, and its possibilities of adjustment, offering the capacity for dynamic adjustment of the shuttering means. Thus, it has been shown that the more the apodization blade penetrates into the beam, the more the effect is accentuated on the photosensitive layer, the slope of the profile being greater. Alternatively, the shuttering means may be chosen from amongst absorption filters, reflection filters, interference filters, neutral-density filters or polarizing filters.

In a second variant illustrated in FIG. 6, the optical beam has radial symmetry down to the level of the plane of the plane photosensitive layers, the optical axis of the focusing optics being perpendicular to the plane of the photosensitive layers, the optical beam being out of focus by a distance d at the plane of the plane photosensitive layers. In order to obtain the sloping effect on the edges of the resist, the beam needs to be defocused beyond the depth of field. This can lead to a loss of resolution, the light waist being broader, and a loss of the exposure power. In order to overcome this drawback, the pre-focusing or focusing optics can introduce spherical aberration into the optical beam in such a manner that the caustic of spherical aberration on the plane of the plane photosensitive layers comprises more energy on its periphery than at its center, thus promoting the photosensitization.

1. A system for laser direct writing on a plane substrate comprising one or more plane photosensitive layers, said system comprising:
a writing laser, an optical beam coming from the writing laser having radial symmetry;
a set of optics for focusing the optical beam onto the plane of the plane photosensitive layers;
means for displacement in translation of the plane substrate, wherein the system comprises optical or mechanical means configured in such a manner that the useful part of the optical beam is inclined on the plane of the photosensitive layers in order to create profiles with an inverted slope within said layers, the useful part of the optical beam being the part of the optical beam which contributes effectively to creating said profiles, the optical axis of the focusing optics being perpendicular to the plane of the photosensitive layers.

2. The laser direct-write system as claimed in claim 1, wherein the system comprises means for partial shuttering of the optical beam situated in the neighborhood of the focusing optics.

3. The laser direct-write system as claimed in claim 2, wherein the shuttering means are an opaque thin plane blade (50) with a straight edge.

4. The laser direct-write system as claimed in claim 2, wherein the shuttering means are an apodization blade allowing an optical beam to be generated on the plane of the plane photosensitive layers such that the useful part of the optical beam is inclined on the plane of the plane photosensitive layers without diffraction fringes.

5. The laser direct-write system as claimed in claim 2, wherein the shuttering means are mounted onto at least one table being adjustable in translation and/or in rotation.

6. The laser direct-write system as claimed in claim 1, wherein the optical beam has radial symmetry down to the level of the plane of the plane photosensitive layers, the optical axis of the focusing optics being perpendicular to the plane of the photosensitive layers, the optical beam being out of focus on the plane of the plane photosensitive layers.

7. The laser direct-write system as claimed in claim 6, wherein the focusing optics introduce spherical aberration into the optical beam in such a manner that the caustic of spherical aberration on the plane of the plane photosensitive layers comprises more energy on its periphery than at its center.

8. A use of the laser direct-write system as claimed in claim 1 for the performance of a step of a photolithographic method.

9. A method for laser direct writing onto a substrate covered by a resist comprising:
providing the laser direct-write system as claimed in claim 1;
processing of said resist by the laser coming from said system.

10. A use of the laser direct-write system as claimed in claim 2 for the performance of a step of a photolithographic method.

11. A use of the laser direct-write system as claimed in claim 6 for the performance of a step of a photolithographic method.

12. A method for laser direct writing onto a substrate covered by a resist comprising:
providing the laser direct-write system as claimed in claim 2;
processing of said resist by the laser coming from said system.

13. A method for laser direct writing onto a substrate covered by a resist comprising:
providing the laser direct-write system as claimed in claim 6;
processing of said resist by the laser coming from said system.
